(19) United States
(12) Patent Application Publication
(10) Pub. No.: US 2009/0095185 A1
(43) Pub. Date: Apr. 16, 2009

(54) WEB-FED PRINTING PRESS

(75) Inventors: Rudolf NAEGELE, Friedberg (DE); Peter Schulmeister, Pfaffenhofen (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/243,524

(22) Filed: Oct. 1, 2008

(30) Foreign Application Priority Data
Oct. 2, 2007 (DE) 10 2007 047 180.9

(51) Int. Cl. B41F 1/54

(52) U.S. Cl. 101/484

(57) ABSTRACT

A web-fed printing press is disclosed. The press includes at least one printing-plate-based printing unit for statically printing a printing substrate web with a static printing image and at least one processing device, in particular a printing-plate-less printing device for dynamically printing at least one printing substrate web surface of a printing substrate web with a variable printed image in-line. The processing device is assigned a sensor, which automatically measures a statically printed printing substrate web and, depending upon the measurement of the printing substrate web, triggers the processing device to position the processing to be performed with the processing device in the transport direction and/or transverse to the transport direction of the printing substrate web at the desired position on the printing substrate web. The processing device is assigned an operating device to make control commands available to the processing device independent of a printing press control system.

This application claims the priority of German Patent Document No. 10 2007 047 180.9, filed Oct. 2, 2007, the disclosure of which is expressly incorporated by reference herein.

### BACKGROUND AND SUMMARY OF THE INVENTION

The invention related to a web-fed printing press.

Web-fed printing presses have several printing-plate-based printing units for statically printing at least one printing substrate web surface of at least one printing substrate web with the same printed image for all printed copies of a print job. Each copy is normally comprised of several printed pages. These types of printing-plate-based printing units, which are used for static printing of the or each printing substrate web, are typically designed as offset printing units. It is likewise possible for the printing-plate-based printing units to be designed as gravure printing units.

In a web-fed printing press, it is already known from practice, in addition to the printing-plate-based printing units, which are used for statically printing the or each printing substrate web with a printed image that is the same for all printed copies, to provide at least one processing device for individualizing the printed copies in-line by dynamic printing in addition to the static printing. Such a processing device may be a printing-plate-less printing device such as, for example, an inkjet printing device, in order to print at least one printing substrate web surface of at least one printing substrate web with a printed image that is variable for at least some printed copies, i.e., dynamic. In addition, this type of processing device may be a coating device or a gluing device or a laser cutting device or a foil transfer device or a perforating device or an imprinting device for RFID or odorous substances or invisible ink or the like.

In the case of web-fed printing presses that have at least one printing-plate-based printing unit for statically printing at least one printing substrate web and at least one processing device for the in-line individualization of at least one printing substrate web, the control-side integration of the or each processing device into the web-fed printing press causes problems, namely particularly when an already existing, conventional web-fed printing press, which up to now has been comprised exclusively of printing-plate-based printing units and no processing devices such as, for example, printing-plate-less inkjet printing devices, is supposed to be retrofitted with at least one such processing device. In this case, there are no possibilities on the existing printing press control system for making control commands available to the or each processing device.

Starting herefrom, the present invention is based on the objective of creating a novel web-fed rotary printing press.

According to the invention, the or each processing unit is respectively assigned a sensor, which automatically measures a statically printed printing substrate web and, depending upon the measurement of the printing substrate web, triggers the respective processing device in order to position the processing to be performed with the processing device, in particular the to-be-printed dynamic printed image, in the transport direction and/or transverse to the transport direction of the printing substrate web at the desired position on the printing substrate web, wherein the or each processing device is assigned an operating device in order to make control commands available to the or each processing device independent of a printing press control system.

The advantage of the present invention is that the or each processing device, which is preferably used for individualizing at least one statically printed printing substrate web, is independent of a printing press control system, because it is possible to make control commands available individually for the or each processing device via an operating device without the aid of the printing press control system. The statically printed printing substrate web is measurable via a sensor assigned to the respective processing device, wherein the respective processing device may be triggered depending upon the measurement of the respective printing substrate web. If the sensor is not able to automatically determine a transport speed of the respective printing substrate web, the respective processing device requires the transport speed of the respective printing substrate web as the only input variable from the web-fed printing press. Otherwise, the or each processing device is self-sufficient on the control side so that, when retrofitting an existing web-fed printing press, no changes to the printing press control system are required. It is possible in a simple manner to retrofit existing web-fed printing presses with processing devices preferably for individualizing statically printed printing substrate webs.

Preferred developments of the invention are yielded from the following description. Without being limited hereto, one exemplary embodiment of the invention is described in greater detail on the basis of the drawing.

### BRIEF DESCRIPTION OF THE DRAWING

FIG. 1 is a schematic section of an inventive web-fed printing press.

### DETAILED DESCRIPTION OF THE DRAWING

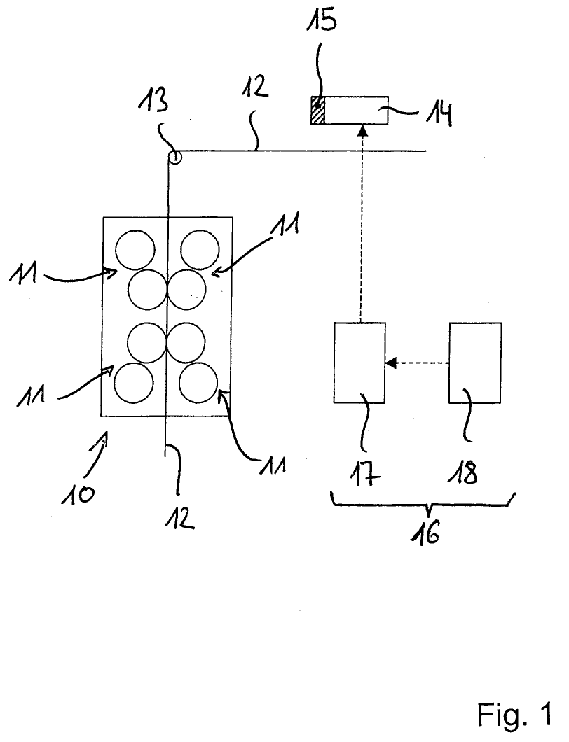

In the following, the invention will be described, making reference to FIG. 1, for the preferred application case of integrating a processing device embodied as an inkjet printing device into a web-fed printing press.

However, the invention is not limited to this application case. In fact, other processing devices such as a coating device or a gluing device or a laser cutting device or a foil transfer device or a perforating device or an imprinting device for RFID or odorous substances or invisible ink or the like may also be integrated into a web-fed printing press within the scope of the invention.

FIG. 1 shows a schematic section of a web-fed printing press embodied as a newspaper printing press in the area of a printing-plate-based printing unit 10. The printing-plate-based printing unit 10 has four printing couples 11, whereby, in the area of the printing unit 10, a web-shaped printing substrate 12, which is transported in the vertical direction through the printing unit 10, may be printed on both sides, i.e., in the area of both printing substrate web surfaces. The printing-plate-based printing unit 10 is used for static printing of the printing substrate web 12 with a printed image that is the same for all printed copies of a print job. Every printed copy is comprised of several printed pages. The printing couples 11 of the printing-plate-based printing unit 10 are preferably designed as offset printing couples. It is also possible to design them as gravure printing couples.

After printing the printing substrate web 12 in the area of the printing unit 10, the printing substrate web 12 may be diverted at a guide roller 13 in such a way that, following the guide roller 13, the printing substrate web 12 is essentially transported in the horizontal direction in order to thereby convey the statically printed printing substrate web 12 to an inkjet printing device 14, which is used to dynamically print a printing substrate web surface of the printing substrate web 12 with a printed image that is variable at least for some printed copies. This makes it possible to individualize the static printed image printed in the printing unit 10.

The inkjet printing device 14 is assigned a sensor 15, which automatically measures the visible printing substrate web surface of the printing substrate web 12 that is printed with a static printed image, wherein, on the one hand, a transverse offset is automatically determined for the inkjet printing device 14 depending upon the measurement in order to position the printed image to be printed with the inkjet printing device 14 transverse to the transport direction of the printing substrate web, as viewed from the desired position on the printing substrate web 12 or a corresponding printed page, and wherein, on the other hand, a triggering signal for the inkjet printing device 14 is automatically determined depending upon the measurement of the printing substrate web 12 in order to position the printed image to be printed with the inkjet printing device 14 in the transport direction of the printing substrate web, as viewed from the desired position on the printing substrate web or the corresponding printed page.

Consequently, the dynamic printed image to be printed by the inkjet printing device 14 is able to be positioned via the sensor 15 in the transport direction of the printing substrate web 12 and transverse to the transport direction of the printing substrate web 12 at a desired position on the printing substrate web 12.

The inkjet printing device is assigned an operating device 16 that is independent of a printing press control system in order to make control commands available to the inkjet printing device 14 independent of the printing press control system. In this case, the operating device 16 according to FIG. 1 is comprised of a computer unit 17 as well as a data entry and display unit 18, wherein the data entry and display unit 18 is preferably embodied as a touch screen on which, on the one hand, control data are displayed, and, on the other hand, control data may be input.

The computer unit 17 generates control commands for the inkjet printing device 14 on the basis of the data entered via the data entry and display unit 18.

Consequently, a web-fed printing press is provided by the invention, wherein the inkjet printing device 14 that is integrated into the web-fed printing press is self-sufficient on the control side and consequently does not require an interface to a printing press control system, in particular to a central control console of the web-fed printing press. The position of the dynamic printing in the transport direction as well as transverse to the transport direction of the printing substrate is automatically and self-sufficiently determined by the sensor 15 assigned to the inkjet printing device 14. Control commands for the inkjet printing device 14 are able to be made available self-sufficiently via the operating device 16 that is independent of the printing press control system. The transport speed of the printing substrate web 12 is the only additional information, which the inkjet printing device 14 requires for proper operation.

The sensor 15 is able to automatically determine the transport speed of the printing substrate web 12 either automatically, or a printing unit 10 positioned upstream from the inkjet printing device 14 makes the transport speed of the printing substrate web 12 available to the inkjet printing device 14. In the case in which the sensor 15, during the measurement of the printing substrate web 12, measures printed marks with a predetermined distance on the printing substrate web, the transport speed of the printing substrate web 12 may be automatically determined by the sensor 15 from the distance of the marks as well as the time between two successive marks. If the precision of this speed determination is not sufficient then it is possible to fall back on a speed signal provided by the printing unit 10 used for the static printing.

The operating device 16 may be used to input, for example, correction commands as control commands for the inkjet printing device 14 in order to correct the position of the dynamic printing of the printing substrate web 12 determined by the sensor 15 in the transport direction as well as transverse to the transport direction of the printing substrate web 12.

In addition, it is possible to input the target position for the dynamic printing by the inkjet printing device 14 with respect to the to-be-measured marks of the printing substrate web 12 as a control command via the operating device 16. In addition, a start command or a stop command for the inkjet printing device 14 may be made available via the operating device 16. Furthermore, maintenance and servicing functions may be invoked using the operating device 16 for the inkjet printing device 14. In addition, status messages and error messages as well as operating tips may be visualized on the operating device 16.

In the case in which the web-fed printing press is comprised of several inkjet printing devices 14 with corresponding sensors 15, control commands may be made available via a common operating device 16 for all inkjet printing devices 14, wherein the operating device 16 may be used to select the inkjet printing device 14 for which current control commands are supposed to be made available.

With the inventive design of a web-fed rotary printing press, it is possible to retrofit existing web-fed rotary printing presses whose printing press control systems are not designed for the integration of inkjet printing devices for dynamic printing of printing substrate webs but only for static printing of the same, with a low expense with inkjet printing devices, because it is possible to make control commands available via the separate operating device for the or each inkjet printing device independent of the printing press control system. Via the sensor of the respective inkjet printing device, the same automatically determines the position for the dynamic printing of the printing substrate web in the transport direction as well as transverse to the transport direction of the printing substrate web. Any speed signal concerning the transport speed of the printing substrate web that may still be required is either determined automatically by the sensor or made available by a printing unit, which is used for the static printing of the printing substrate web.

List of Reference Numbers:
10 Printing unit
11 Printing couple
12 Printing substrate web
13 Guide roller
14 Inkjet printing device
15 Sensor
16 Operating device
17 Computer unit
18 Data entry and display unit

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A web-fed printing press comprising a printing-plate-based printing unit for statically printing a printing substrate web with a static printing image for printed copies of a print job and a processing device positioned downstream from the printing-plate-based printing unit and upstream from a folding unit, wherein the processing device is assigned a sensor which automatically measures a statically printed printing substrate web and, depending upon a measurement of the printing substrate web by the sensor, triggers the processing device in order to position a processing to be performed with the processing device in a transport direction of the printing substrate web and/or in a direction transverse to the transport direction at a position on the printing substrate web, and wherein the processing device is assigned an operating device which provides a control command to the processing device independent of a printing press control system.

2. The web-fed printing press according to claim 1, wherein the processing device is a printing-plate-less printing device for dynamically printing the printing substrate web with a variable printed image.

3. The web-fed printing press according to claim 1, further comprising a second processing device and wherein the second processing device is assigned the operating device, which provides a control command to the second processing device independent of the printing press control system.

4. The web-fed printing press according to claim 3, wherein a processing device for which a control command is to be made available is selectable via the operating device.

5. The web-fed printing press according to claim 1, wherein a correction command is inputtable as the control command via the operating device in order to correct the position of the processing on the printing substrate web in the transport direction and/or in the direction transverse to the transport direction of the printing substrate web.

6. The web-fed printing press according to claim 1, wherein a target position of the processing on the printing substrate web is inputtable as the control command via the operating device.

7. The web-fed printing press according to claim 1, wherein a maintenance command is inputtable as the control command via the operating device.

8. The web-fed printing press according to claim 1, wherein, in addition to the control command provided via the operating device, a transport speed of the printing substrate web is provided to the processing device by a component of the web-fed printing press.

9. The web-fed printing press according to claim 8, wherein the component is a printing-plate-based printing unit.

10. The web-fed printing press according to claim 1, wherein the sensor automatically determines a transport speed of the printing substrate web.

11. The web-fed printing press according to claim 1, wherein the operating device is comprised of a computer unit and a data entry and display unit.

12. A method for operating a web-fed printing press, comprising the steps of:
statically printing a printing substrate web by a printing-plate-based printing unit with a static printing image;
measuring the printing substrate web printed with the static printing image with a sensor;
depending upon the measuring of the printing substrate web by the sensor, triggering a processing device to position a processing to be performed with the processing device in a transport direction of the printing substrate web and/or in a direction transverse to the transport direction at a position on the printing substrate web; and
providing a command to the processing device by an operating device which is independent of a printing press control system.

13. The method according to claim 12, wherein the processing device is a printing-plate-less printing device and wherein the processing is dynamically printing the printing substrate web with a variable printed image.

14. The method according to claim 12, wherein the command is a correction command to correct the position on the printing substrate web.

15. The method according to claim 12, wherein the command is a target position of the processing on the printing substrate web.

16. The method according to claim 12, wherein the command is a maintenance command.

17. The method according to claim 12, further comprising the step of providing a transport speed of the printing substrate web to the processing device by a component of the web-fed printing press.

18. The method according to claim 17, wherein the component is a printing-plate-based printing unit.

19. The method according to claim 12, further comprising the step of determining a transport speed of the printing substrate web by the sensor.

20. The method according to claim 12, wherein the operating device is a computer unit and a data entry and display unit.
